(19) United States
(12) Patent Application Publication
(10) Pub. No.: US 2012/0286743 A1
(43) Pub. Date: Nov. 15, 2012

(54) SYSTEM AND METHOD FOR GENERATING A NEGATIVE CAPACITANCE

(75) Inventors: Mohammed Soltani, Montreal (CA); Mohamed Chaker, Montreal (CA)

(73) Assignee: INSTITUT NATIONAL DE RECHERCHE SCIENTIFIQUE (INRS), Quebec (CA)

(21) Appl. No.: 13/469,577

(22) Filed: May 11, 2012

Related U.S. Application Data
(60) Provisional application No. 61/485,689, filed on May 13, 2011.

(51) Int. Cl. H02J 7/00

(52) U.S. Cl. 320/166

(57) ABSTRACT

A method of generating a negative capacitance in a capacitor device is provided. The method comprises providing the capacitor device. The capacitor device comprises an active layer of vanadium dioxide (VO₂) and two electrodes connected thereto. The active layer is excitable between its semiconducting state and its metallic state. The method comprises exciting the active layer with an excitation source, thereby bringing the active layer from the semiconducting state to the metallic state and generating the negative capacitance between the two electrodes. Systems for generating a negative capacitance are also provided.

### CROSS-REFERENCE TO RELATED APPLICATIONS

The present application is a regular application claiming priority to U.S. Provisional Application Ser. No. 61/485,689, filed May 13, 2011, entitled ‘VANADIUM DIOXIDE NEGATIVE CAPACITOR DEVICE’, the entirety of which is incorporated herein by reference.

### TECHNICAL FIELD

The present relates to negative capacitor devices and methods for generating a negative capacitance, and particularly to devices and methods involving vanadium dioxide negative capacitors.

### BACKGROUND

In electrical and electronical circuits, unwanted capacitance, or parasitic capacitance, can arise between electronic components (or parts thereof) of the circuits due to their proximity. Parasitic capacitance can be found in circuits that include radio frequency (RF) active band-pass filters, electrostatic actuators, piezoelectric actuators, sound-shielding systems, to name a few. This unwanted capacitance may affect the performances of the electrical and electronical circuits.

The current approach to cancel the generated parasitic capacitances involves components that have a negative capacitance. A negative capacitance is a capacitance of negative value. By choosing a component that has a negative capacitance of same (or similar) value as the parasitic capacitance, yet of negative sign, one can cancel the parasitic capacitance.

Despite the effectiveness of the negative capacitance approach, setting up negative capacitor devices can be cumbersome. Often one has to develop complex electrical circuits which require sought after choices of the electrical components and adequate and complex control of electrical currents flowing therethrough.

Therefore, there is a need for an improved negative capacitor device.

### SUMMARY

The present aims to overcome at least some of the inconveniences mentioned above. In one aspect, a method of generating a negative capacitance in a capacitor device comprises providing the capacitor device. The capacitor device comprises an active layer of vanadium dioxide (VO₂) and two electrodes connected thereto. The active layer is excitable between a semiconducting state and a metallic state. The active layer is at the semiconducting state. The method comprises exciting the active layer with an excitation source, thereby bringing the active layer from the semiconducting state to the metallic state and generating the negative capacitance between the two electrodes.

In an additional aspect, the excitation source is a voltage supplying source. Exciting the active layer with an excitation source comprises connecting the two electrodes to the voltage supplying source, and applying a bias Direct Current (DC) voltage. The biased DC voltage is selected to allow the active layer to be brought from the semiconducting state to the metallic state.

In a further aspect, the capacitor device comprises a substrate having a receiving surface. The active layer is deposited onto the receiving surface, and the two electrical electrodes are deposited at least partially onto the active layer.

In an additional aspect, the excitation source is a light source. Exciting the active layer with an excitation source comprises illuminating the active layer with the light source at a predetermined wavelength. The predetermined wavelength excites the active layer from the semiconducting state to the metallic state.

In a further aspect, the active layer includes doped VO₂.

In an additional aspect, the method comprises exhibiting a hysteresis memory effect as a result of bringing the active layer from the semiconducting state to the metallic state.

In another aspect, a system for generating a negative capacitance comprises a capacitor device comprising an active layer of vanadium dioxide (VO₂) and two electrodes connected thereto. The active layer is excitable between a semiconducting state and a metallic state. An excitation source is operatively connected to the capacitor device. When in operation, the excitation source bringing the active layer from the semiconducting state to the metallic state thereby generating the negative capacitance between the two electrodes.

In an additional aspect, the excitation source comprises a voltage supplying source connected to the two electrodes. When in operation the voltage supplying source applying a bias Direct Current (DC) voltage adapted to bring the active layer from the semiconducting state to the metallic state.

In a further aspect, the capacitor device further comprises a substrate having a receiving surface. The active layer is deposited onto the receiving surface and the two electrical electrodes being deposited at least partially onto the active layer.

In an additional aspect, the capacitor device further comprises a dielectric layer and a conductive substrate. The dielectric layer is disposed between the active layer and the conductive substrate.

In a further aspect, a transparent electrically conducting material is deposited on top of the active layer.

In an additional aspect, the active layer includes doped VO₂.

In a further aspect, the VO₂ is doped with W.

In an additional aspect, the active layer includes VO₂-x.

In a further aspect, the excitation source is a light source having a predetermined wavelength. Illuminating the active layer with the light source at the predetermined wavelength brings the layer from the semiconducting state to the metallic state.

In an additional aspect, the excitation source is one of voltage, temperature, carrier charge injection and pressure.

In yet another aspect, a system for generating a negative capacitance comprises an array of capacitor devices. Each of the capacitor devices comprises an active layer of vanadium dioxide (VO₂) and two electrodes connected thereto. The active layers have each a semiconducting state and a metallic state. A single excitation source is operatively connected to the array of capacitor devices. When in operation, the excitation source brings the active layers of the capacitor devices from the semiconducting state to the metallic state thereby generating the negative capacitance between the two electrodes.

In a further aspect, the single excitation source is one of voltage, temperature, carrier charge injection and pressure.

### BRIEF DESCRIPTION OF THE DRAWINGS

Further features and advantages of the present invention will become apparent from the following detailed description, taken in combination with the appended drawings, in which:

FIG. 1 illustrates a system for generating a negative capacitance, in accordance with an embodiment;

FIG. 2 schematically illustrates a vanadium dioxide capacitor, in accordance with a first embodiment;

FIG. 3 schematically illustrates a vanadium dioxide capacitor, in accordance with a second embodiment;

FIG. 4 schematically illustrates a vanadium dioxide capacitor, in accordance with a third embodiment;

FIG. 5a is a front view of a W-doped VO₂/Al₂O₃ planar micro-switch, in accordance with an embodiment;

FIG. 5b is a perspective view of the W-doped VO₂/Al₂O₃ planar micro-switch of FIG. 5a;

FIG. 6a illustrates I-V characteristics of the W-doped VO₂/Al₂O₃ planar micro-switch of FIG. 5a, in accordance with an embodiment;

FIG. 6b illustrates an electrical resistance of the switch of FIG. 5a as a function of a current applied to the planar switch, in accordance with an embodiment;

FIGS. 7a and 7b illustrates a conductance and a capacitance, respectively, for the micro-switch of FIG. 5a as a function of frequency when a bias voltage of 0 V and 35 V is applied to the micro-switch, in accordance with an embodiment;

FIG. 8 illustrates a lower frequency range (1-100 KHz) dependence of a capacitance of the micro-switch of FIG. 5a for semiconducting (at 1V) and metallic (at 35 V) states while the insert illustrates the frequency dependence of capacitance at a bias voltage of 1V, in accordance with an embodiment;

FIGS. 9a, 9b, and 9c respectively illustrate C-V characteristics (with positive and negative capacitance) of the micro-switch of FIG. 5a for three different frequencies, in accordance with an embodiment;

FIG. 10 illustrates a C-V hysteresis memory effect (with positive and negative capacitance) of the micro-switch of FIG. 5a at 1.5 MHz, in accordance with an embodiment;

FIG. 11 illustrates a C-V hysteresis memory effect (with positive capacitance) of a standard capacitor (C=1.59 10⁻¹⁰ F) in parallel with the micro-switch of FIG. 5a, in accordance with an embodiment;

FIG. 12 schematically illustrates an array of VO₂ capacitor devices, in accordance with an embodiment;

FIG. 13 illustrates a multi-layer negative capacitor device, in accordance with a first embodiment;

FIG. 14 illustrates a multi-layer negative capacitor device, in accordance with a second embodiment; and

FIG. 15 illustrates a multi-layer negative capacitor device, in accordance with a third embodiment.

It will be noted that throughout the appended drawings, like features are identified by like reference numerals.

### DETAILED DESCRIPTION

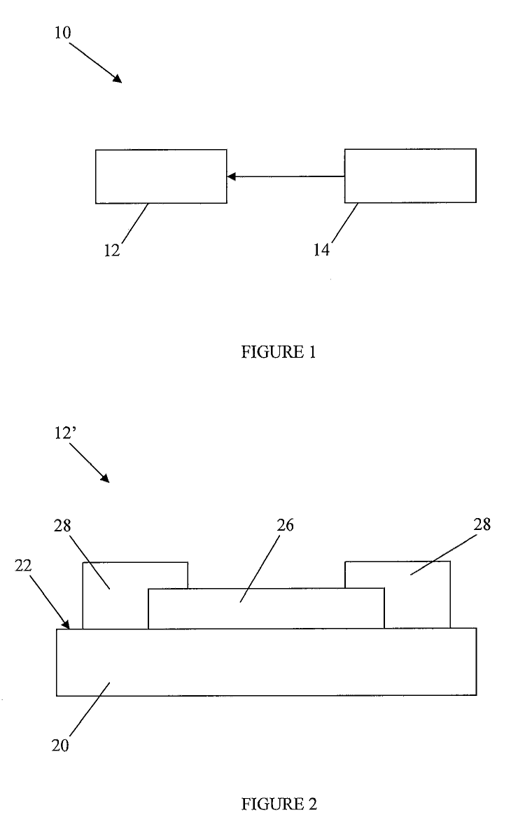

FIG. 1 illustrates one embodiment of a system 10 for generating a negative capacitance. The system 10 comprises a capacitor 12 and an excitation source 14. The capacitor 12 includes Vanadium dioxide (VO₂). When excited by the excitation source 14, VO₂ can exhibit a semiconductor-to-metallic phase transition (SMT) (i.e. a transition from a semiconducting state—or phase—to a metallic state—or phase—) at a substantially low transition temperature Tₜ (typically about 68° C.). The excitation source 14 includes external stimuli such as temperature, photo-excitation, electric field, carrier injection, pressure (some of which will be described below). A control unit (not shown) can be used to control the excitation source 14. Alternatively, the excitation may be controlled directly from the excitation source 14, i.e. the control unit may be integral with the excitation source 14.

The SMT is accompanied by a drastic change of electrical and optical properties in the infrared region. The VO₂ electrical resistivity may decrease by several orders of magnitude as temperature increases. In addition, while it transmits light in the semiconducting state, VO₂ becomes substantially reflective and opaque in the metallic state. The inventors have surprisingly discovered that VO₂ material can exhibit negative capacitance under adequate circumstances. Such adequate circumstance will be described below. While VO₂ has a positive capacitance when in the semiconducting state, it exhibits a negative capacitance when in the metallic state. The negative capacitance can be used to at least reduce parasitic capacitance in electrical and electronical circuits. The negative capacitance exhibited by the VO₂ during SMT is the basis for the systems and methods for generating a negative capacitance described herein.

With respect to other vanadium oxides such as Vanadium Pentoxide (V₂O₅), VO₂ presents a faster transition between the semiconducting state and the metallic state, i.e. a shorter SMT duration. The ultrafast transition of VO₂ is usually the range of picoseconds. As a result, a capacitor comprising VO₂ may be suitable for integration in fast electrical circuits in which fast generation of negative capacitances is required.

VO₂ material can thus be exploited in various technological applications comprising all-optical switches, electro-optical switches, uncooled IR microbolometers, smart windows, and the like.

In one embodiment, the capacitor 12 comprising VO₂ material presents a negative capacitance when an AC electric field having a frequency between 1 kHz and 10 MHz is applied thereto.

In the same or another embodiment, the capacitor 12 presents a negative capacitance when an AC electric field having a frequency in the range of Gigahertz and/or Terahertz is applied thereto.

In one embodiment, pressure is used for switching the VO₂ material from the semiconducting material into the metallic material and the capacitor 12 can be the basis for a fingerprint sensor for example.

In one embodiment, the capacitor device 12 exhibits a hysteresis memory effect and can be the basis for a random access memory device.

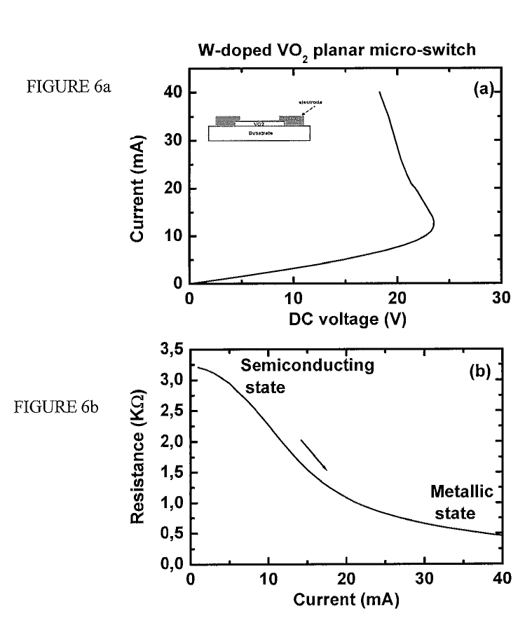

FIG. 2 illustrates one embodiment of a capacitor device 12′ that may be used in the system 10. The capacitor device 12′ comprises an electrically insulating substrate 20 having a top or receiving surface 22 on which an active layer of VO₂ 26 is deposited. Two electrodes 28 physically independent one from the other and made of an electrical conducting material are deposited partially on the receiving surface 22 of the substrate 20 and partially on the VO₂ layer 26 so as to be in physical contact with the VO₂ layer 26 in order to propagate an electrical field therethrough. When the VO₂ layer 26 is brought to the metallic state by an adequate excitation via the excitation source 14, a negative capacitance can be measured between the two electrodes 28. An example of adequate excitation will be described below with respect to FIGS. 6a to 8.

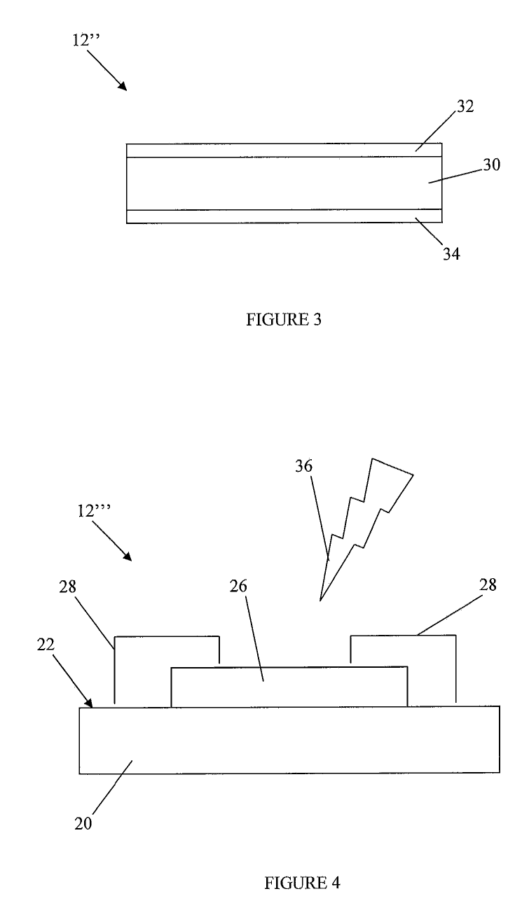

FIG. 3 illustrates another embodiment of a VO₂ capacitor device 12″, which may be used in the system 10 for generating a negative capacitance. The capacitor device 12″ comprises a layer 30 of VO₂ sandwiched between two electrical conductive layers 32 and 34. The two layers 32 and 34 are electrodes. Upon excitation by the excitation source 14, the

Furthermore, VO₂ also presents a lower transition temperature Tₜ with respect to other vanadium oxides. As a result, VO₂ renders possible the generation of negative capacitance at substantially low temperature. Because a substantially low temperature can be used to generate a negative capacitance, such capacitor can be fabricated with a limited number of components. Furthermore, since it is possible to control the transition temperature for VO₂ by adequately doping the VO₂, it is possible to obtain a VO₂ capacitor having a negative capacitance at room temperature or at any desired temperature by controlling the concentration of the doping. For example, VO₂ can be doped with an adequate quantity of a dopant such as Tungsten (W), Titanium (Ti), Aluminum (Al), and/or the like, so that the transition temperature Tₜ substantially corresponds to a desired transition temperature such as room temperature for example. An example of VO₂ doped with Tungsten will be described below.

In one embodiment, the system 10 may be used as an electrically programmable capacitor device. In this case, the capacitance of the VO2 capacitor device 12 is maintained at a desired level by controlling the excitation of the excitation source. For example, a predetermined and desired capacitance can be obtained by applying a corresponding predetermined bias DC voltage to the capacitor 12.

In one embodiment, since the capacitance of the capacitor device 12 varies under optical excitation, the capacitor 12 can be used as a light sensor or capacitive Infrared (IR) uncooled microbolometer.

In one embodiment, the capacitor device 12 includes a thin film of VO₂.

In one embodiment, the system 10 can be used for improving the performance of devices such as RF active band-pass filters, electrostatic actuators, piezoelectric actuators, sound-shielding systems, monolithic-microwave integrated circuit (MMIC) varactor diode, and the like.

In one embodiment, the optical and/or electrical hysteresis of the VO₂ capacitor device can be reduced or substantially eliminated by co-doping the VO₂ with adequate dopants. For example, VO₂ may be doped with W and Ti. The SMT characteristics of doped conductive layers 32, 34 apply an electrical field through the VO₂ layer 30, and the VO₂ layer 30 reaches the metallic state. At the metallic state, a negative capacitance is generated between the two electrodes 32 and 34.

It should be understood that the capacitor devices 12′ and 12″ are exemplary only and that any adequate capacitor device 12 comprising VO₂ material connected to two electrodes for propagating an electrical field through the VO₂ material may be used in the system 10 for generating a negative capacitance.

In one embodiment, the excitation source 14 is a voltage supply source electrically connected to the electrodes of the capacitor device 12, such as electrodes 28 or 32 and 34 for example. The voltage supply source is adapted to apply a bias Direct Current (DC) voltage through the VO₂ material of the capacitor device. The bias DC voltage has a value adapted to switch the VO₂ material from the semiconducting state to the metallic state. In this case, by applying the bias DC voltage between the two electrodes of the capacitor device, the VO₂ material of the capacitor reaches the metallic state and a negative capacitance is generated between the two electrodes. It should be understood that an Alternate Current (AC) voltage may be applied to the capacitor device 12 as a bias voltage for switching the VO₂ material between the semiconducting and metallic states and generating an oscillating capacitor.

FIG. 4 illustrates another embodiment of a VO₂ capacitor device 12′″ in which, the excitation source 14 comprises a light source 36 adapted to illuminate the VO₂ material 26 comprised in the capacitor device 12′″. The electrodes 28 are used to record the capacitance or to connect the VO2 capacitor device 12′″ to the external circuits. By selecting the power and wavelength of the light source 36, one can force the VO₂ material 26 contained in the capacitor device 12 to switch to the metallic state so that it exhibits a negative capacitance. For example, the VO2 layer 26 can be optically switched by beam laser at 980 nm with power laser of 23 mW. An example of STM transition using a light source is described in the publication entitled “1×2 optical switch devices based on semiconductor-to-metallic phase transition characteristics of VO2 smart coatings” Soltani et al. Meas. Sci. Technol. 17 1052 (2006) pp 5, the entirety of which is incorporated by reference.

In one embodiment, the excitation source 14 generates light having a wavelength comprised in the optical spectrum from visible to far-infrared for switching the capacitor device 12 into the metallic state.

It should be understood that excitation sources other than the light source 36 or by applying an electric field may be used for bringing the VO₂ material 26 contained in the capacitor device 12 in the metallic state. As mentioned above, the capacitor device 12 may be heated up to a temperature at least equal to the transition temperature Tₜ, using any adequate heating device. Alternatively, external stimuli such as pressure, carrier injection, and the like may be used to switch the VO₂ material from the semiconducting state to the metallic state.

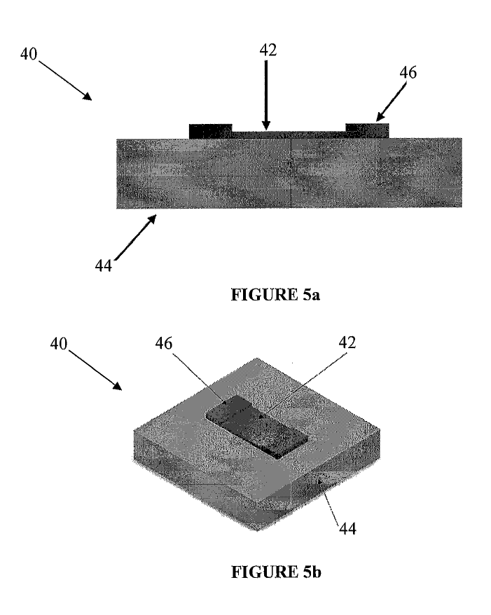

Turning now to FIGS. 5a to 9, a negative capacitor device in the shape of a planar micro-switch 40 comprising doped VO₂ material will be described. Experimental results on the doped VO₂ material will also be described. The experiments and experimental results on the doped VO2 material are also described in the publication ‘Electrically tunable sign of capacitance in planar W-doped vanadium dioxide micro-switches’ by Soltani et al., Sci. Technol. Adv. Mater. 12 (2011) 045002 (6 pp), the entirety of which is incorporated herein by reference.

Referring to FIGS. 5a et 5b, the negative capacitor 40 is similar to the capacitor 12′ described above, but comprises a layer 42 of doped VO₂. The layer 42 is made of thermochromic W(1.4 at. %)-doped VO₂. The layer 42 is 150 nm thick and was synthesized onto a c-Al₂O₃(0001) substrate 44 using reactive pulsed laser deposition. Standard photolithography followed by plasma etching was used to pattern the layer into the planar micro-switch 40. The planar micro-switch 40 is 100 μm wide by 1000 μm long. Electrical contacts 46 include a NiCr layer integrated over the micro-switch 40 by lift-off process. The NiCr layer is 150 nm thick. It is contemplated that the planar micro-switch 40 and its components could have dimensions different from the ones described above.

Using such a structure [W(1.4 at. %)-doped VO₂/c-Al₂O₃(0001)], it has been demonstrated that the SMT can be exploited for the fabrication of planar micro-optical switch driven by substantially low external voltage, i.e. about 28V. The temperature dependence of electrical resistance for this device showed that the SMT occurs at about 36° C. A reversible transmittance switching (on/off) as high as 28 dB was achieved at λ=1.55 μm. In addition, its transmittance switching modulation was demonstrated at λ=1.55 μm by controlling the SMT with superposition of DC and Alternate Current (AC) voltages.

The device was switched reversibly on-off during about 10 000 cycles without any degradation of its performance (i.e. the transmittance switching modulation was completely reversible and reproducible).

The DC current-voltage (I-V) characteristic of the fabricated micro-switch 40 was recorded at room temperature using a semiconductor parameter analyzer (HP 4145A). The dependence of the capacitance on both DC voltage and frequency as well as the micro-switch conductance were measured at room temperature using a low-frequency impedance analyzer (HP 4192A) at an oscillating voltage level of 50 mV. The micro-switch device 40 was directly connected to the HP measurement systems without using any external load electrical resistance. The choice of the W-doped VO₂ as active layer for the fabrication of the micro-switch device 40 is motivated by its lower electrical resistance as compared to undoped VO₂. This enables control of its SMT with relatively low external voltage lying in the range of voltage provided by the HP system.

FIG. 6a illustrates the DC I-V characteristics of the W-doped VO₂ planar micro-switch 40. The voltage induced in the micro-switch 40 by a current varying from 0 up to 40 mA was measured. The voltage is observed to monotonously increase with current until it reaches a maximum value Vₜₕ of about 23.5 V at a current Iₜₕ of about 13 mA. Beyond this current, the voltage decreases while the current further increases. This phenomenon indicates a negative differential resistance. The negative resistance effect actually occurs when the W-doped VO₂ layer is in the metallic state. FIG. 6b illustrates the variation of the electrical resistance as a function of the applied current. It is shown that the W-doped VO₂ material switches from the semiconducting state (high resistance) to the metallic state (low resistance).

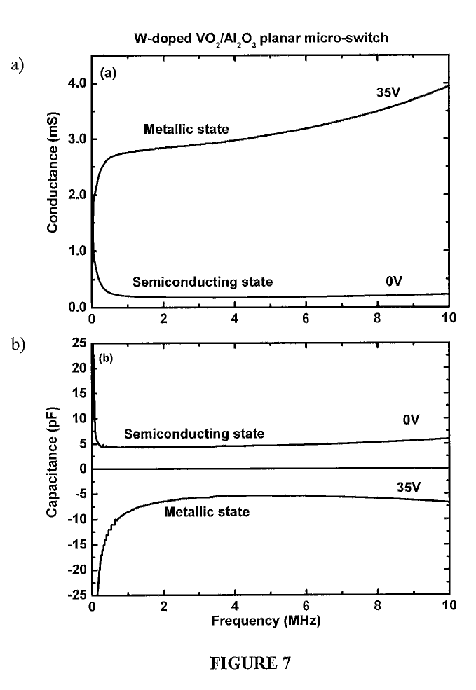

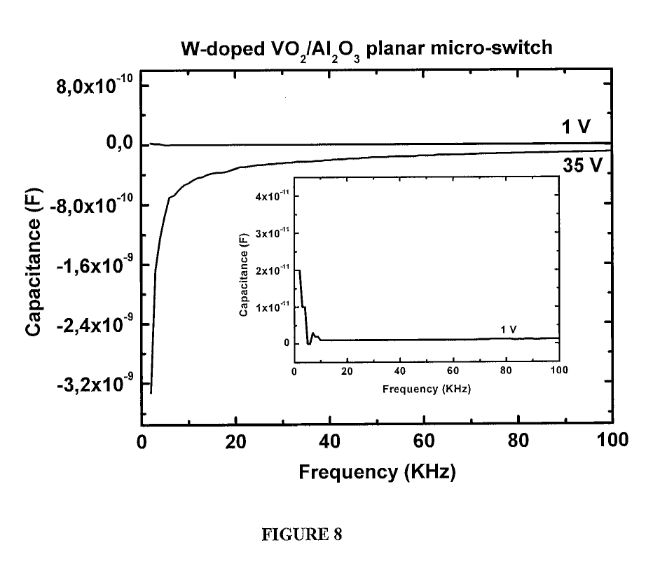

FIGS. 7a and 7b respectively illustrate the frequency dependence (from 1 kHz up to 10 MHz) of both conductance (FIG. 7a) and capacitance (FIG. 7b) of the W-doped VO₂ micro-switch 40 for the semiconducting state (at a DC bias voltage of 0 V) and the metallic state (at a DC bias voltage of 35 V). FIG. 8 illustrates the low frequency range (1-100 KHz) dependence at bias voltage of 1 V and 35 V. As can be seen, the behaviour of conductance and capacitance differs depending whether the VO₂ state is semiconducting or metallic. Overall, as expected, the metallic state is more conducting than the semiconducting state [see FIGS. 7a and 8]. However, surprisingly, the metallic state is characterized by a negative capacitance [see FIG. 7b], while being always positive in the semiconducting state. The detailed analysis of FIG. 7b shows that in the low frequency region, the capacitance of the semiconducting state decreases abruptly. The capacitance then reaches a broad minimum and increases slowly at higher frequency. The opposite behaviour is observed for the metallic state since the capacitance increases rapidly with frequency, reaching a broad maximum to finally decrease slowly at higher frequency. Above 1 MHz, the capacitance switching contrast, defined as the capacitance difference between the two states, is about 10 pF.

In order to investigate the negative capacitance effect, the capacitance was measured at three different frequencies as a function of the DC bias voltage (from −35V up to 35V). The applied switching sequence was chosen in such a way that the initial state is metallic state, when the DC bias voltage is equal to −35V, then switches to semiconducting state (at 0 V) and changes to metallic state again (at 35 V).

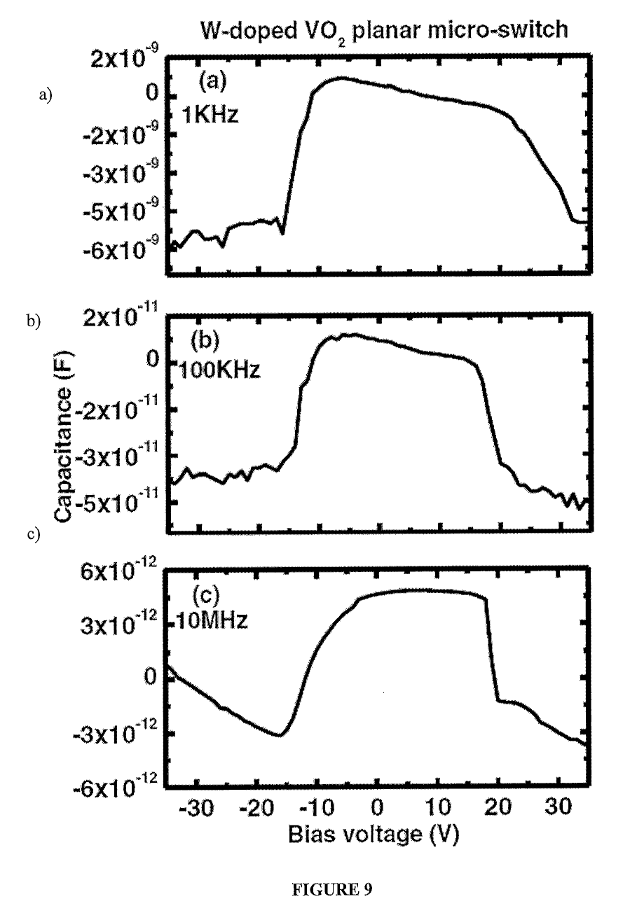

FIGS. 9a, 9b, and 9c compare the measured C-V characteristics at 1 kHz, 100 kHz, and 10 MHz, respectively. At 1 kHz, the capacitance is initially negative and substantially constant, and starts to increase at about −15 V to reach a positive value at about −10 V. Beyond this voltage, the capacitance continues to slightly increase, reaches a maximum at about −7 V and then decreases slowly up to about 20 V and faster beyond this value. A somewhat similar behaviour is observed at 100 kHz even though the return towards negative values takes place at a lower voltage (about 15 V rather than about 20 V). At 10 MHz, the capacitance is initially slightly negative and decreases significantly to reach a minimum value at about −15 V. It subsequently increases, crossing the zero line at about −12 V. It then remains positive up to about 20 V and decreases again to negative values. Overall, the sign of the capacitance is correlated with the W-doped VO₂ states. It should be noted that the capacitance switching contrast decreases with increasing frequency. For example, the capacitance switching contrast is about 6 nF at 1 kHz and 5.7 pF at 10 MHz. In addition, the corresponding conductance (not shown here) behaves at the opposite of the capacitance as it is larger for the metallic state than for the semiconducting state.

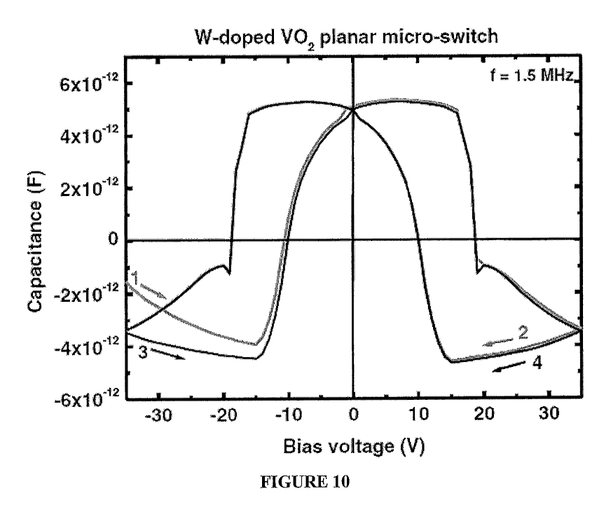

FIG. 10 illustrates the C-V hysteresis that was obtained by measuring the capacitance of the device when the bias voltage cycle was alternatively reversed between −35 V and to 35 V. These capacitance measurements were reversible and reproducible as shown by the four C curves labelled 1, 2, 3, and 4, which were recorded sequentially. The curve 1 was recorded when the active layer was switched directly to the metallic state at −35V (for this first measure, the bias voltage was switched directly from 0 V to −35 V), while the successive curves, i.e. curves 2, 3, and 4, were recorded when the SMT of the active layer was controlled gradually by the bias voltage. The active layer's switching history may explain the small difference observed in the metallic region around −35 V (see curve 1). The C-V curve obtained for increasing voltage is substantially the mirror image of that resulting from decreasing voltage. The hysteresis width is typically 6-8 V. This C-V hysteresis memory effect can be used in the fabrication of advanced memcapacitive systems exploiting the SMT of VO₂, for example.

In one embodiment, devices requiring negative capacitance can be improved by replacing NC-electrical circuits by simple VO₂-negative-capacitor devices which may offer simplicity and easy control of the SMT (i.e., the control of the capacitance) by various external stimuli such as temperature, photo-excitation, electric field, carrier injection, pressure, and the like. In one embodiment, the VO₂ negative capacitor can be used to reduce the sub-threshold swing in field effect transistors (FET) and improve their gain. In addition, the ultra-fast phase transition of VO₂ can be exploited in fabrication of some ultra-fast capacitor sensors.

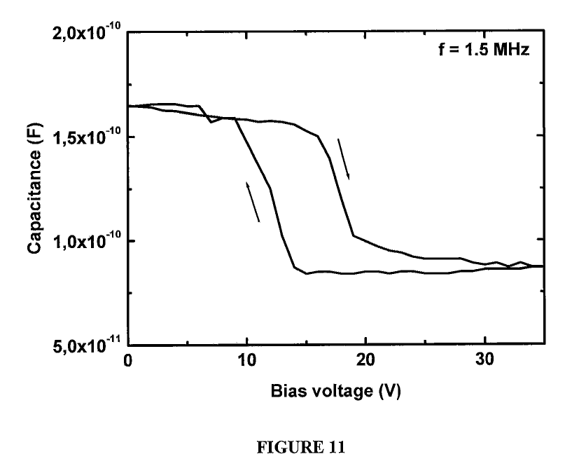

In one embodiment, a VO₂ negative capacitor device can be combined with standard capacitors to fabricate tunable capacitor devices exhibiting C-V hysteresis memory effect with positive capacitance. For example, FIG. 11 illustrates the positive C-V hysteresis as measured for standard capacitor (C=1.59 10⁻¹⁰ F) in parallel with the VO₂ negative capacitor device. The hysteresis width is about 5 V.

The origin of negative capacitance may be attributed to many factors such as minority carrier flow, interface states, slow transition time of injected carriers, charge trapping, space charge, and the like. It was also shown that negative capacitance may appear if the conductivity is inertial (i.e., current lags behind voltage oscillation).

External electric-field induces a formation of conducting filament or current channel at the surface of VO₂. Recently, it has been reported that the formation of the current channel is responsible for the multi-step resistance switching observed in I-V characteristics of planar VO₂/c-Al₂O₃. In the present case, the observed negative capacitance and the variation of the conductance cannot be uniquely explained by the formation of current channel under the applied switching voltage. Indeed, the present experimental results show clearly that the observed negative capacitance is directly linked to the electrically-induced increased conductivity in the active layer. In addition, the time-dependent characteristics of electric field-induced phase transition in planar VO₂/c-Al₂O₃ structure has been investigated, and it has been observed a marked change of the differential conductance that indicates an increase of carrier density (hence of conductivity) under the applied electric-field that results in a change of the state density near the Fermi level.

The frequency dependence of capacitance can be derived from Fourier analysis as:

$$C ( ω ) = {C}_{0} + \frac{1}{ωδ V} {\int }_{0}^{∞} [ - \frac{d δ I ( t )}{d t} ] sin ω t d t \qquad Eq . 1$$

where ω is the angular frequency, δI(t) is the transient current resulting from the application of small voltage step variation δV superimposed to the DC bias voltage V at t=0, and C₀ is the geometric capacitance.

The negative capacitance effect may occur when the time derivative of the transient current [δI(t)/dt] is positive or non-monotonous with time. For homogeneous semiconductor structures, it has been demonstrated that negative capacitance arises when the conductivity is inertial and that the reactive component of the current is larger than the displacement current. In this case, the transient current is related to the DC conductivity (σ). The capacitance can thus be expressed as a function of σ as:

$$C ( ω ) = {C}_{0} - \frac{A 4 π τ σ}{d ( 1 + {ω}^{2} {τ}^{2} )} \qquad Eq . 2$$

where τ is the dielectric relaxation time, A the area of the semiconductor, and d the thickness.

At very high frequency, i.e. when ω→∞, the second term of both Eqs. 1 and 2 becomes negligible. The capacitance is therefore positive and tends towards the geometric capacitance C₀. However, at low frequency, the second term of Eqs. 1 and 2 can become higher than C₀, which results in a negative capacitance.

As shown in FIG. 6a, the I-V characteristic significantly changes in the region where SMT occurs. This feature is characterized by the onset of a negative differential resistance at a threshold voltage Vₜₕ as mentioned above. It can be expected to be accompanied by an increase of the charge density to a critical value N_{c}, which results in a conductivity increase, i.e. a decrease of electrical resistance with increasing current. In these conditions, one can empirically describe σ by an exponential law:

$$σ ( V ) = {σ}_{0} exp [ \frac{- ( {V}_{th} - V ) {E}_{a}}{{V}_{th} K T} ] \qquad Eq . 3$$

where σ₀ the conductivity at Vₜₕ, K the Boltzmann constant, T the temperature, Eₐ the activation energy, i.e. the minimum energy required to initiate the conductivity change. Its value is related to the Fermi level and to the charge carriers in the materials.

Combining Eqs. 2 and 3 provides the dependence of the capacitance on both ω and V in the form:

$$C ( ω , V ) = {C}_{0} - \frac{A 4 π τ}{d ( 1 + {ω}^{2} {τ}^{2} )} {σ}_{0} exp [ \frac{- ( {V}_{th} - V ) {E}_{a}}{{V}_{th} K T} ] \qquad Eq . 4$$

Eq. (4) indicates that the capacitance may negative if the exponential is large enough, which may occur when V is larger than Vₜₕ. As mentioned above, the conductance measurements indicate that the W-doped VO₂ becomes more conductive as the switching voltage increases as shown in FIG. 7a. Therefore, the observed negative capacitance can reasonably be inferred to the electrically-induced enhancement of σ.

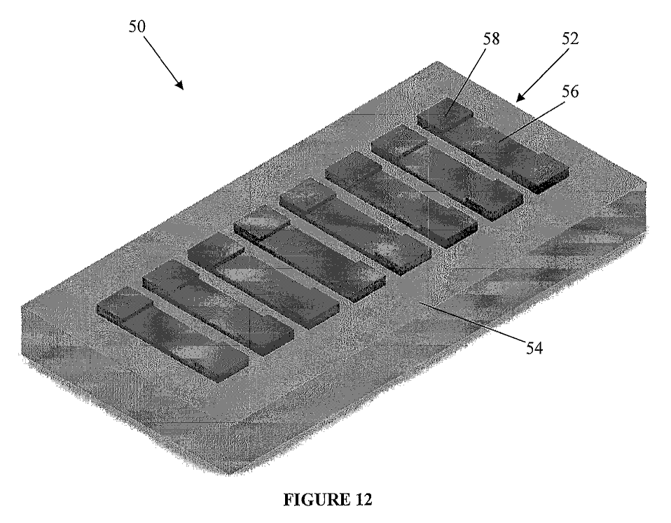

Turning now to FIG. 12, an embodiment of an electrically programmable VO₂-multi-capacitor arrays device 50 will be described. The device 50 comprises an array of VO₂ capacitor devices 52 disposed onto an electrically insulating substrate 54. Each VO₂ capacitor device 52 comprises a layer of VO₂ material 56 and two electrodes 58. The value of the capacitance for each VO₂ capacitor device is individually controllable by an external excitation source (not show). The external excitation source could be a bias DC voltage source, an AC bias voltage source, or a light source for example. The VO₂ capacitor devices 52 may be electrically connected together in series or in parallel to provide a desired capacitance value.

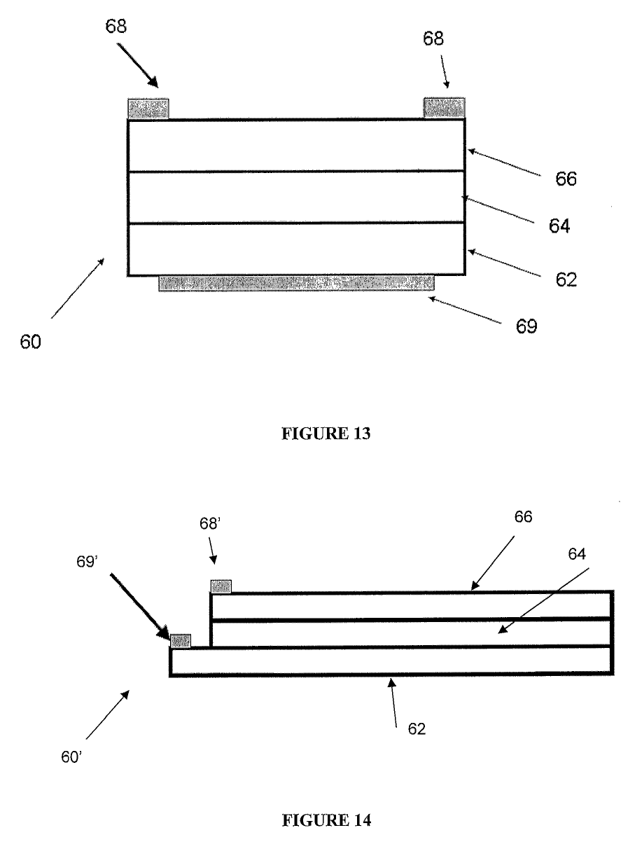

FIG. 13 illustrates one embodiment of a multi-layer negative capacitor device 60 comprising an electrically conducting substrate 62 having a capacitance C3, a VO₂ layer 66 having a capacitance C1, and a dielectric layer 64 having a capacitance C2 disposed therebetween. A first pair of electrodes 68 is secured to the VO₂ layer and a second electrode 69 is connected to the substrate. The characteristics for the different layers 62, 64, 66 including their material, their thickness, and the like are chosen so that their equivalent capacitance is negative at least when the VO₂ material is brought into the metallic state by an external excitation.

While in FIG. 13, the electrodes 68, 69 connected to the electrically conducting substrate are disposed on a bottom of the substrate 62, FIG. 14 illustrates another embodiment of a multi-layer negative capacitor device 60′ in which a substrate 62′ has a surface are larger than that of a dielectric layer 64′ and a VO₂ layer 66′ so that a portion of the substrate 62′ is not covered by the dielectric layer 64′ and VO₂ layers 6′. In this embodiment, electrode 69′ connected to the substrate 62′ is secured on a top of the substrate 62′ in the uncovered region thereof, while electrode 68′ is secured on a top of the VO₂ layer 66′.

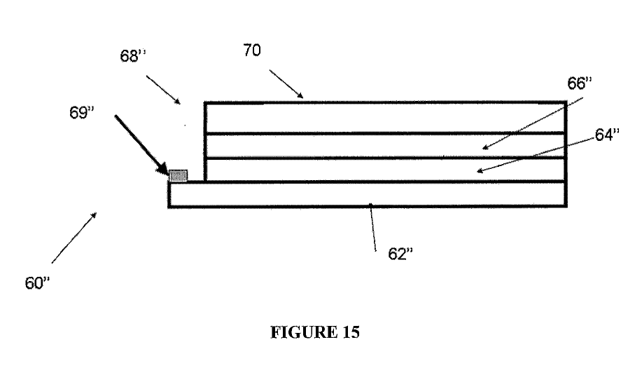

FIG. 15 illustrates one embodiment of a multi-layer negative capacitor device 60″ in which a transparent electrically conducting material 70 is deposited on top of a VO2 layer 66′ to form an electrode 68″. A dielectric layer 64′ is sandwiched between the VO2 layer 66″ and an electrically conducting substrate 64″ provided with an electrode 69″.

The dielectric layers 64, 64′, 64″ for the multi-layer devices 60, 60′, 60″ illustrated in FIGS. 12, 13, and 14 may be made from any adequate material such as SiO2, Si3N4, polymer, or the like, and can form a thin dielectric layer.

While the present description refers to VO₂ material which can be doped or not, it should be understood that VO₂-x material may also be used as long as its composition is substantially close to the stoichiometry of VO₂.

The embodiments of the invention described above are intended to be exemplary only. The scope of the invention is therefore intended to be limited solely by the scope of the appended claims.

1. A method of generating a negative capacitance in a capacitor device, the method comprising:
providing the capacitor device, the capacitor device comprising an active layer of vanadium dioxide (VO₂) and two electrodes connected thereto, the active layer being excitable between a semiconducting state and a metallic state, the active layer being at the semiconducting state; and
exciting the active layer with an excitation source, thereby bringing the active layer from the semiconducting state to the metallic state and generating the negative capacitance between the two electrodes.

2. The method of claim 1, wherein the excitation source is a voltage supplying source;
and exciting the active layer with an excitation source comprises:
connecting the two electrodes to the voltage supplying source; and
applying a bias Direct Current (DC) voltage, the biased DC voltage being selected to allow the active layer to be brought from the semiconducting state to the metallic state.

3. The method of claim 1, wherein the capacitor device comprises a substrate having a receiving surface, the active layer being deposited onto the receiving surface, and the two electrical electrodes being deposited at least partially onto the active layer.

4. The method of claim 1, wherein the excitation source is a light source; and exciting the active layer with an excitation source comprises:
illuminating the active layer with the light source at a predetermined wavelength, the predetermined wavelength exciting the active layer from the semiconducting state to the metallic state.

5. The method of claim 1, wherein the active layer includes doped VO₂.

6. The method of claim 1, further comprising exhibiting a hysteresis memory effect as a result of bringing the active layer from the semiconducting state to the metallic state.

7. A system for generating a negative capacitance, the system comprising:
a capacitor device comprising an active layer of vanadium dioxide (VO₂) and two electrodes connected thereto, the active layer being excitable between a semiconducting state and a metallic state; and
an excitation source operatively connected to the capacitor device, when in operation, the excitation source bringing the active layer from the semiconducting state to the metallic state thereby generating the negative capacitance between the two electrodes.

8. The system of claim 7, wherein the excitation source comprises a voltage supplying source connected to the two electrodes, when in operation the voltage supplying source applying a bias Direct Current (DC) voltage adapted to bring the active layer from the semiconducting state to the metallic state.

9. The system of claim 8 wherein the capacitor device further comprises a substrate having a receiving surface, the active layer being deposited onto the receiving surface and the two electrical electrodes being deposited at least partially onto the active layer.

10. The system of claim 7, wherein the capacitor device further comprises a dielectric layer and a conductive substrate, the dielectric layer being disposed between the active layer and the conductive substrate.

11. The system of claim 10, further comprising a transparent electrically conducting material deposited on top of the active layer.

12. The system of claim 7, wherein the active layer includes doped VO₂.

13. The system of claim 12, wherein the VO₂ is doped with W.

14. The system of claim 7, wherein the active layer includes VO₂-x.

15. The system of claim 7, wherein the excitation source is a light source having a predetermined wavelength, wherein illuminating the active layer with the light source at the predetermined wavelength brings the layer from the semiconducting state to the metallic state.

16. The system of claim 7, wherein the excitation source is one of voltage, temperature, carrier charge injection and pressure.

17. A system for generating a negative capacitance, the system comprising:
an array of capacitor devices, each of the capacitor devices comprising an active layer of vanadium dioxide (VO₂) and two electrodes connected thereto, the active layers having each a semiconducting state and a metallic state; and
a single excitation source operatively connected to the array of capacitor devices, when in operation, the excitation source bringing the active layers of the capacitor devices from the semiconducting state to the metallic state thereby generating the negative capacitance between the two electrodes.

18. The system of claim 17, wherein the single excitation source is one of voltage, temperature, carrier charge injection and pressure.
